(19) United States
(12) Patent Application Publication
(10) Pub. No.: US 2008/0106115 A1
(43) Pub. Date: May 8, 2008

(54) RECREATIONAL VEHICLE TOP AND DOORS ASSEMBLY

(76) Inventor: Samuel Hughes, Martin, KY (US)

Correspondence Address: INTELLECTUAL PROPERTY / TECHNOLOGY LAW, PO BOX 14329, RESEARCH TRIANGLE PARK, NC, 27709, US

(21) Appl. No.: 11/558,925

(22) Filed: Nov. 12, 2006

Related U.S. Application Data
(63) Continuation-in-part of application No. 29/250,168, filed on Nov. 4, 2006, now Pat. No. D549638.
Application No. 29/250,168 is a continuation-in-part of application No. 29/250,169, filed on Nov. 4, 2006, now Pat. No. D549630.

(51) Int. Cl. B62D 25/06

(52) U.S. Cl. 296/102; 296/146.1

(57) ABSTRACT

Twin sheet vacuum thermoformed vehicular top and doors, adapted for mounting on a roll cage of a recreational vehicle, in which the thermoformed article includes complementary sections thermally bonded to one another along a continuous peripheral edge seam. Each of the complementary sections has an exterior surface that is grained and an interior surface that is ungrained. The vehicular top and doors can be provided as components of a kit for accessorizing a recreational vehicle, and such kit can further include foldable windshield and rear bumper components, as well as mounting hardware for the various components of the kit.

### CROSS-REFERENCE TO RELATED APPLICATIONS

This is a continuation-in-part of U.S. Design Pat. Application 29/250,168 filed Nov. 4, 2006 and U.S. Design Pat. Application 29/250,169 filed Nov. 4, 2006. Priority of said applications is claimed under 35 U.S.C. § 120. The disclosures of said U.S. design Pat. applications are hereby incorporated herein in their respective entireties, for all purposes.

### BACKGROUND OF THE INVENTION

1. Field of the Invention

The present invention relates to recreational vehicle accessories, and more particularly to recreational vehicle twin sheet thermoformed tops and side doors, and to recreational vehicle accessory kits including twin sheet thermoformed tops and side doors, optionally further including a foldable windshield and rear-bumper components, as well as to a vacuum thermoforming method for fabricating such vacuum thermoformed articles, and to recreational vehicles accessorized with such vacuum thermoformed articles.

2. Description of the Related Art

In the recreational vehicles industry, a wide variety of two-wheeled and four-wheeled vehicles have been commercialized. One widely commercialized vehicle of the four-wheeled type is the Yamaha Rhino, commercially available from Yamaha Motor Corporation in various models, including the Rhino 660 4×4 model. Other commercially available recreational vehicles of such four-wheeled type, including utility all-terrain vehicles, and side-by-side models, include the Polaris Ranger, commercially available from Polaris Industries, Inc. and the Arctic Cat Prowler commercially available from Arctic Cat Inc.

Various after-market accessories are generally available for recreational vehicles of such type, including customization kits commercialized by various manufacturers.

In the design, manufacture and commercialization of such after-market accessory products, it is necessary to address utilitarian as well as safety aspects of the vehicle that is being modified by the after-market accessories.

Recreational vehicles in many cases are originally manufactured with open passenger compartments, and when such vehicles are used for cross-country or forested terrain travel, the drivers as well as passengers in such recreational vehicles are exposed to the elements, including for example dirt, gravel, rocks, debris, branches, etc., as the vehicle is driven in various off-road locations. Recreational vehicle after-market accessories therefore should be structurally robust and adaptable to such diverse terrain conditions. There is also a significant need for accessories that enhance the safety and comfort of persons traveling in such recreational vehicles.

### SUMMARY OF THE INVENTION

The present invention relates to recreational vehicle accessories, and more particularly to recreational vehicle tops and side doors, and to a recreational vehicle accessory kit including twin sheet vacuum thermoformed top and side doors, optionally further including a foldable windshield and rear-bumper components, as well as to a vacuum thermoforming method for fabricating such vacuum thermoformed articles, and to recreational vehicles accessorized with such vacuum thermoformed articles.

In one aspect, the invention relates to a twin sheet vacuum thermoformed vehicular top, adapted for mounting on a roll cage of a recreational vehicle, said vehicular top comprising top and bottom sections thermally bonded to one another along a continuous peripheral edge seam therebetween to enclose an interior void volume bounded by said top and bottom sections and said peripheral seam, wherein each of said top and bottom sections has an exterior surface that is grained and an interior surface that is ungrained.

In another aspect, the invention relates to a twin sheet vacuum thermoformed door, adapted for mounting on a roll cage of a recreational vehicle, said door comprising first and second sections thermally bonded to one another along a continuous peripheral edge seam therebetween to enclose an interior void volume bounded by said first and second sections and said peripheral seam, wherein each of said first and second sections has an exterior surface that is grained and an interior surface that is ungrained.

In a further aspect, the invention relates to an accessory kit for accessorizing a recreational vehicle including a roll cage structure, said kit comprising:
(a) a twin sheet vacuum thermoformed vehicular top, adapted for mounting on a roll cage of a recreational vehicle, said vehicular top comprising top and bottom half-sections thermally bonded to one another along a continuous peripheral edge seam therebetween to enclose an interior void volume bounded by said top and bottom half-sections and said peripheral seam, wherein each of said top and bottom half-sections has an exterior surface that is grained and an interior surface that is ungrained; and
(b) twin sheet vacuum thermoformed doors, adapted for mounting on a roll cage of a recreational vehicle, said doors comprising first and second half-sections thermally bonded to one another along a continuous peripheral edge seam therebetween to enclose an interior void volume bounded by said first and second half-sections and said peripheral seam, wherein each of said first and second half-sections has an exterior surface that is grained and an interior surface that is ungrained.

A further aspect of the invention relates to a recreational vehicle including a roll cage arranged to surround an interior compartment of the vehicle, said recreational vehicle including at least one of:
(a) a twin sheet vacuum thermoformed vehicular top, mounted on the roll cage of the recreational vehicle, said vehicular top comprising top and bottom sections thermally bonded to one another along a continuous peripheral edge seam therebetween to enclose an interior void volume bounded by said top and bottom sections and said peripheral seam, wherein each of said top and bottom sections has an exterior surface that is grained and an interior surface that is ungrained; and
(b) twin sheet vacuum thermoformed doors secured to the roll cage of the recreational vehicle at respective sides thereof, each of said doors comprising first and second sections thermally bonded to one another along a continuous peripheral edge seam therebetween to enclose an interior void volume bounded by said first and second sections and said peripheral seam, wherein each of said first and second sections has an exterior surface that is grained and an interior surface that is ungrained.

A still further aspect of the invention relates to a method of making an article selected from among recreational vehicle tops and side doors, said method comprising forming complementary molded sections of said article by a twin sheet vacuum thermoforming process, and mating said complementary sections under elevated temperature conditions to form a bonded unitary article including the molded sections enclosing an interior void volume, wherein each of said molded sections has an exterior surface that is grained and an interior surface that is ungrained.

Other aspects, features and embodiments of the invention will be more fully apparent from the ensuing disclosure and appended claims.

### BRIEF DESCRIPTION OF THE DRAWINGS

FIG. 1 is a perspective view of a two-seat, four-wheeled recreational vehicle, modified with accessories of the present invention, in one embodiment thereof.

FIG. 2 is another, frontal perspective view of the recreational vehicle of FIG. 1.

FIG. 3 is a rear perspective view of the recreational vehicle of FIGS. 1 and 2.

FIG. 4 is an upper, front and right side perspective view of a recreational vehicle top, according to one embodiment of the present invention.

FIG. 5 is a lower, rear and left side perspective view of the recreational vehicle top of FIG. 4.

FIG. 6 is a top plan view of the recreational vehicle top of FIGS. 4 and 5.

FIG. 7 is a bottom plan view of the recreational vehicle top of FIG. 6.

FIG. 8 is a side elevation view of the recreational vehicle top of FIGS. 4-7, the respective sides of the top being symmetrical to one another.

FIG. 9 is a rear elevation view of the recreational vehicle top of FIGS. 4-8.

FIG. 10 is a rear elevation view of the recreational vehicle top of FIGS. 4-9.

FIG. 11 is a rear perspective view of a portion of the recreational vehicle of FIGS. 1-3 showing details of the recreational top, as mounted on the roll cage of such vehicle.

FIG. 12 is a front perspective view of a portion of the recreational vehicle of FIGS. 1-3 showing the recreational top as mounted on the roll cage of such vehicle.

FIG. 13 is a perspective view of a portion of the vehicle of FIGS. 1-3, showing the details of the headlamp assemblies of the recreational vehicle top.

FIG. 14 is a perspective interior view of the front accessory panel of the recreational vehicle top of the FIGS. 1-3 recreational vehicle.

FIG. 15 is a perspective interior view of the rear accessory panel of the recreational vehicle top shown in FIGS. 11-14.

FIG. 16 is a perspective interior view of the central panel body of the front accessory panel of the recreational vehicle top of FIGS. 11-15.

FIG. 17 is a perspective view of a portion of the recreational vehicle of FIGS. 1-3, showing details of the side door accessory.

FIG. 18 is a perspective view of the recreational vehicle of FIG. 17, showing the ready manual removal of the side door, involving lifting of same off its hinge spindles.

FIG. 19 is a perspective close-up view of the side door assembly of FIGS. 17 and 18, showing details of the side door and door mounting panel assembly.

FIG. 20 is a perspective view of a recreational vehicle door, according to one embodiment of the invention.

FIG. 21 is a top plan view of the door of FIG. 20.

FIG. 22 is a bottom plan view of the door of FIG. 20.

FIG. 23 is a side elevation view of the door of FIG. 20, such door being provided in duplicate and the doors being symmetrical to one another.

FIG. 24 is a front elevation view of the door of FIG. 23.

FIG. 25 is a rear elevation view of the door of FIG. 23.

### DETAILED DESCRIPTION OF THE INVENTION, AND PREFERRED EMBODIMENTS THEREOF

The present invention relates to recreational vehicle accessories, and more specifically to recreational vehicle twin sheet thermoformed tops and side doors, and to methods for making the same, and to recreational vehicles equipped with such accessories. The vehicle top is adapted for mounting on the roll cage of a recreational vehicle, and the doors are adapted to be mounted on such roll cage at the respective sides of the vehicle, utilizing a door mounting panel secured to the roll cage.

The invention also relates to a recreational vehicle accessory kit including twin sheet thermoformed top and side doors, optionally further including a foldable windshield and rear-bumper components, for modification of recreational vehicles, to enhance their utility and safety.

The top and door accessories of the invention may be provided, in various embodiments, as components of an accessory kit. The accessory kit in additional embodiments includes a folding windshield that is adapted to be coupled to the roll cage of a recreational vehicle, at a front portion of such roll cage structure. In other embodiments, the accessory kit further includes a rear bumper adapted for securement to the chassis of a vehicle, and adapted to protect tail lights of such vehicle from impact and damage.

The vehicular top and side doors of the invention can be formed of any suitable thermoplastic material of appropriate character. Acrylonitrile butadiene styrene (ABS), fluoropolymers, polyamides, polyarylates, polycarbonate, polyimides, polyamideimides, polyetherimides, polyoxymethylene (POM acetal), polyphenylene oxide, polyaryletherketones, polysulfones, polyethersulfones, polyphenylene sulfides, and liquid crystal polymers, and copolymers of monomers of the foregoing polymers, and blends and composites containing same, are among materials that can be employed as thermoforming materials of construction for the vehicular top and doors of the invention. The forming material may contain any of various suitable thermoplastics additives, such as anti-oxidants, uv stabilizers, fillers, pigments, colorants, anti-static agents, plasticizers, mold release additives, etc.

In one preferred embodiment, the thermoplastic material used for manufacturing the twin sheet thermoformed top and door articles of the invention is an ABS material that is filled with carbon black powder.

The thermoformed vehicular top and doors of the invention may be manufactured and sold in the form of an after-market accessory kit, optionally including a foldable windshield, bumper assembly components, and/or any further accessories that may complement the vehicular top and doors, e.g., to enhance the safety, use, enjoyment, etc. of the vehicle. The accessory kit including the thermoformed top and doors can be packaged in any suitable fashion appropriate for shipment, display, delivery, etc., and may further be packaged with assembly and operating instructions, further customization information, etc.

The vehicle itself can be of any suitable type, such as the aforementioned Yamaha Rhino, commercially available from Yamaha Motor Corporation, the Polaris Ranger, commercially available from Polaris Industries, Inc. and the Arctic Cat Prowler, commercially available from Arctic Cat Inc. In one preferred embodiment, the recreational vehicle is a Yamaha Rhino vehicle.

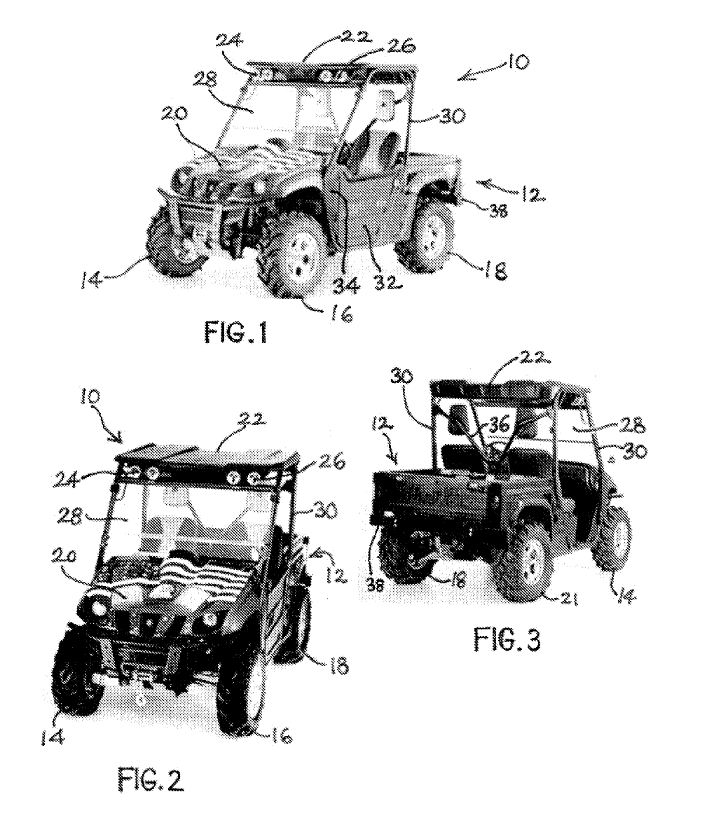

Referring now to the drawings, FIG. 1 is a perspective view of a two-seat, four-wheeled recreational vehicle 10, modified with the accessories of the present invention, in one embodiment thereof. The recreational vehicle 10 includes a chassis 12 mounted on wheels 14, 16, 18, and 21, as shown more fully in FIGS. 2 and 3, FIG. 2 being another, frontal perspective view of the recreational vehicle of FIG. 1, and FIG. 3 being a rear perspective view thereof.

The chassis of the recreational vehicle as commercialized by the original equipment manufacturer includes a roll cage 30, which as shown in the rear perspective view of FIG. 3 is open to the passenger compartment, and as shown in FIGS. 1 and 2 is equipped with a side door accessory of the invention, as hereinafter more fully described.

The roll cage 30 includes a roll cage reinforcement member 36 of wishbone shape at the rear of the roll cage, spanning the rear struts thereof.

The roll cage thus circumscribes the interior vehicular compartment containing driver and passenger seat components. The chassis 12 includes a hood 20 on which is mountable retention elements accommodating fold-down of the foldable windshield 28, as a further component of the accessories of the present invention, in various embodiments thereof. The windshield is secured to the front struts of the roll cage 30 by suitable coupling, clamping or mechanical fastening elements, whereby the windshield may be retained in a first “up” position as shown, spanning the front struts of the roll cage. In a second position, the windshield 28 is folded forwardly and downwardly to selectively engage the aforementioned retention elements on the hood 20, so that the windshield is in a “down” position and allows free flow of air through the interior vehicular compartment, unobstructed by the windshield.

The accessory kit of the present invention in various embodiments includes vehicular top and side door components. In the accessorized vehicle embodiment of FIGS. 1-3, in which the basic vehicle in the form supplied by the original equipment manufacturer has been modified by the vehicular top and side doors of the invention, the top 22 includes a front portion adapted to mount headlamp arrays 24 and 26. Array 24 is a right-hand array of headlamps, and array 26 is a left-hand array of headlamps.

Components of the accessorized vehicle illustratively shown in FIGS. 1-3 as provided from an accessory kit of the invention can include, in addition to the top and side door components, the above-described foldable windshield 28, as well as the rear bumper 38. Such bumper may for example be constructed of steel or other hard metal or plastic material, which may be powder coated or otherwise finished to provide an appearance that is consistent with the vehicle. The bumper 38 may be mounted on the chassis 12 with suitable mounting hardware, including brackets, mechanical fasteners, etc.

The bumper in a preferred embodiment is arranged to be mounted on the vehicle so as to protect any associated rear lamps or illumination devices on the rear portion of the vehicle, such as tail lights, backup lights, running lights, etc.

As shown in FIGS. 1-3, the vehicular top 22 is adapted to cooperatively mate with the upper portion of the roll cage 30, being secured to the roll cage by suitable mechanical fasteners, clamps, brackets, or other mounting hardware. The vehicular top 22 is a twin sheet thermoformed top, being formed of twin sheet elements that are thermoformed and mated with one another to form a unitary product structure, as hereinafter more fully described.

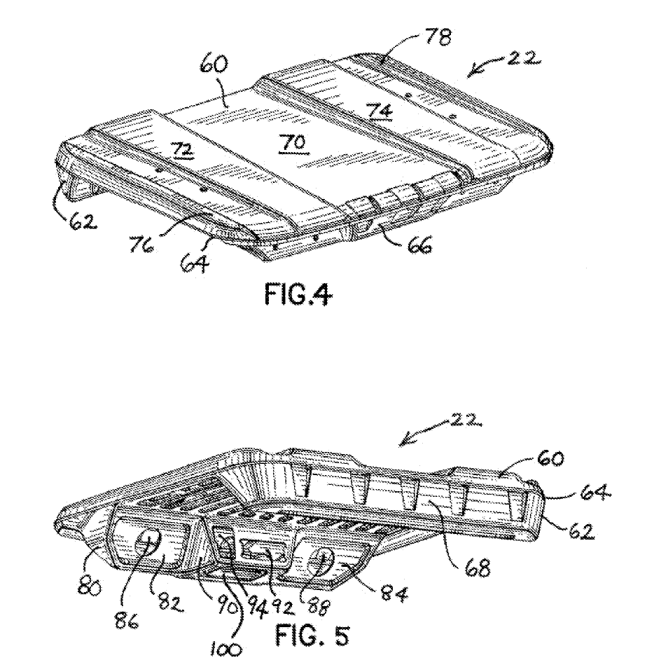

FIG. 4 is an upper, front and right side perspective view of a recreational vehicle top, according to one embodiment of the present invention, of a type as shown in FIGS. 1-3.

The twin sheet thermoformed top 22 as indicated is formed from twin sheets. The twin sheets are formed by thermoforming molding to provide an upper sheet body 60 and a lower sheet body 62, as joined at a thermoforming joint 64 created by heat and pressure consolidation of the upper and lower sheet bodies as molded to the illustrated shape or other suitable conformation.

The top 22 includes a leading edge portion 66, with which is associated a front accessory panel 80 (see FIG. 5). The front accessory panel depends downwardly from the front portion of the vehicular top at such frontal portion thereof, to present panels for accessorizing the vehicle on which the vehicular top is installed.

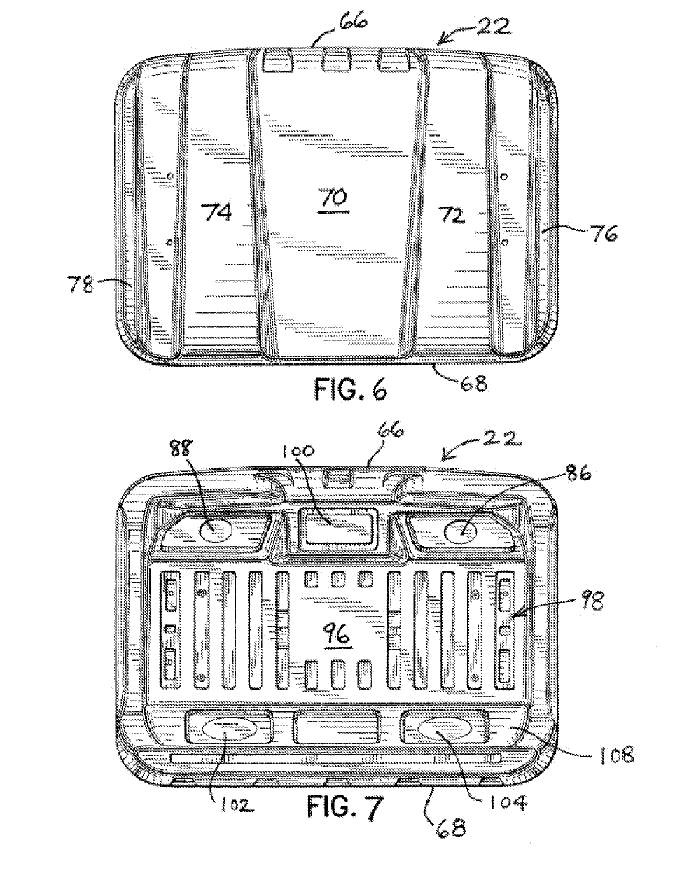

As shown in FIG. 4, the vehicular top 22 includes on the upper sheet body 60 a main top surface 70, from which upwardly extends the top right raised surface portion 72 and the top left raised surface portion 74. Each of these raised surface portions is of a rearwardly outwardly flaring character, as shown in the top plan view of FIG. 6, and each of such raised surface portions increases in height from the leading edge portion 66 of the top 22, to the trailing edge portion 68 thereof (see FIG. 5). The top 22 at its outer side regions features two additional raised surface portions of the upper sheet body, comprising the right marginal raised surface portion 76 and left marginal raised surface portion 78. These marginal raised surface portions, as shown in the top plan view of FIG. 6, also are rearwardly upwardly and outwardly flaring in character.

The front accessory panel 80 of the vehicular top is more fully shown in the lower, rear and left side perspective view of FIG. 5.

The front accessory panel 80 includes a left panel face 82 having a left speaker opening 86 therein to accommodate installation of a speaker of an audio system. The front accessory panel 80 also includes a corresponding right panel face 84 having right speaker opening 88 therein, for the same purpose.

The front accessory panel 80 further includes a central panel body 90 extending rearwardly and terminating in a panel including main accessory opening 92 and auxiliary accessory opening 94 therein, for installation of audio system components, clock or GPS apparatus, displays, or any other instrumentation or accessories such as audiovisual systems, two-way radio or walkie-talkie components, computer systems, etc.

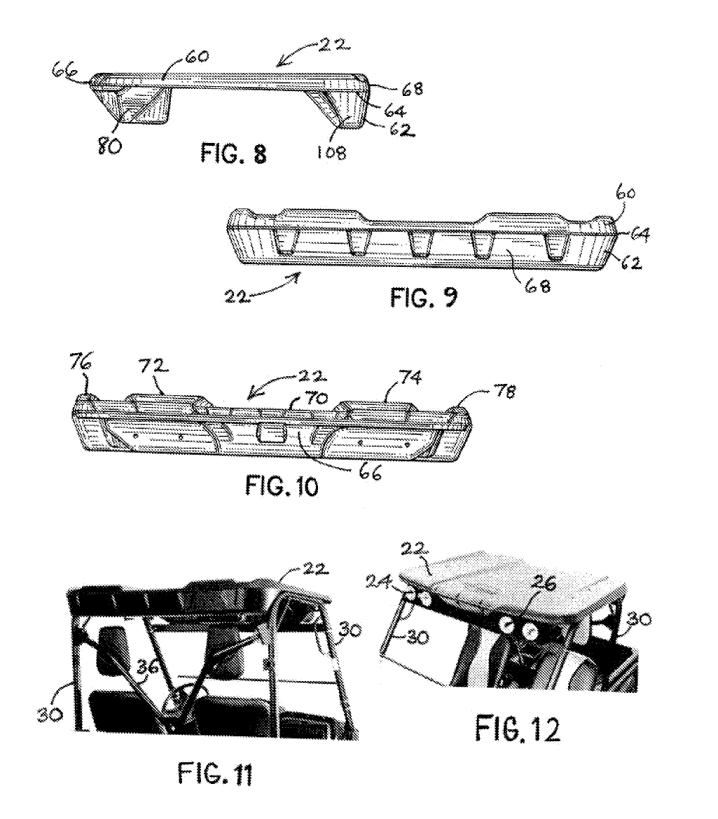

The central panel body 90 extends rearwardly, as shown in the side elevation view of FIG. 8, and has a flat central panel bottom surface 100, which in the embodiment shown is of solid character, but which may alternatively comprise a cut-out or opening, to accommodate interior lighting for the vehicle, or other accessories.

The central panel body 80 optionally contains in the interior compartment thereof electrical circuitry elements, e.g., wiring harness, electrical contacts and connectors, etc., to accommodate the various electrical and electronic components that may be installed in or used with the recreational vehicle with which the vehicular top 22 is associated.

FIG. 6 is a top plan view of the recreational vehicle top 22 of FIGS. 4 and 5.

As shown, the upper sheet body is aerodynamically styled with the aforementioned raised surface portions.

FIG. 7 is a bottom plan view of the recreational vehicle top article of FIG. 6.

As shown, the vehicular top 22 includes a main bottom surface 96 having an array 98 of elongate ridge (rib) elements thereon, each extending longitudinally on the main bottom surface, and with the array extending laterally across the main bottom surface. The view shown in FIG. 7 includes the respective speaker openings 86, 88, 102 and 104 in the vehicular top, whereby four audio speakers may be installed therein as part of an integrated sound system for the vehicle.

FIG. 8 is a side elevation view of the recreational vehicle top 22 of FIGS. 4-7, the respective sides being symmetrical to one another.

As shown, the top is shaped so as to conformably mate with the roll cage of the recreational vehicle, as more fully shown in FIGS. 11-15, discussed hereinafter.

FIG. 9 is a rear elevation view of the recreational vehicle top of FIGS. 4-8 and FIG. 10 is a rear elevation view thereof.

FIG. 11 is a rear perspective view of a portion of the recreational vehicle of FIGS. 1-3, showing details of the recreational vehicle top 22, as mounted on the roll cage 30 of such vehicle. FIG. 11 also shows the wishbone-shaped roll cage reinforcement member 36, as employed to impart structural rigidity to the roll bar structure surrounding the interior compartment of the recreational vehicle.

FIG. 12 is a front perspective view of a portion of the recreational vehicle of FIGS. 1-3, showing the recreational vehicle top 22 as installed on the roll cage of such vehicle. The view shown in FIG. 12 includes the twin headlamp assemblies 24 and 26 mounted on the leading edge portion of the vehicular top, and electrically connected to the aforementioned internal electrical circuitry in the front accessory panel interior volume, with such electrical circuitry in turn being coupled with the battery of the vehicle, to power the headlamps and other accessories, e.g., sound system, GPS, interior compartment lighting, audiovisual equipment, etc., with which the top is further accessorized.

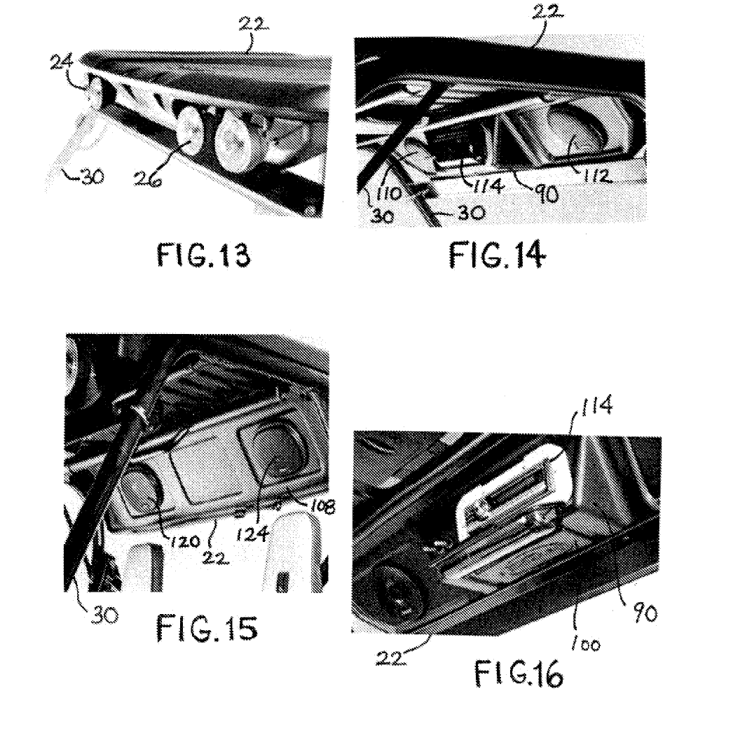

FIG. 13 is a perspective view of a portion of the vehicle of FIGS. 1-3, showing in further close-up the details of the headlamp assemblies mounted on the recreational vehicle top. FIG. 14 is a perspective interior view of the front accessory panel of the recreational vehicle top 22 of the FIGS. 1-3 recreational vehicle.

As shown in FIG. 13, the front accessory panel includes the central panel body 90 having an audio player 114 disposed therein and operatively coupled, through the aforementioned electrical circuitry, to left speaker 110 and right speaker 112 in the front accessory panel.

FIG. 15 is a perspective interior view of the rear accessory panel of the recreational vehicle top shown in FIGS. 11-14. As shown in FIG. 15, the rear accessory panel 108 includes a right speaker 120 and left speaker 124 operatively coupled with electrical circuitry in the interior volume of the rear accessory panel, and coupled to the battery of the recreational vehicle, e.g., in circuit arrangement with the wiring in the front accessory panel 80 previously described.

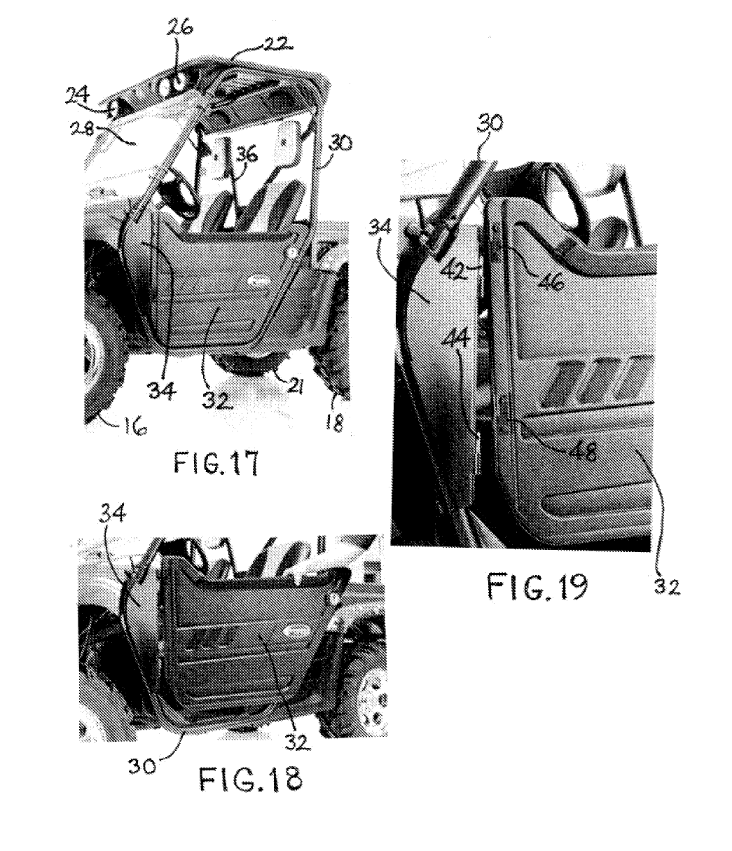

FIG. 16 is a perspective interior view of the central panel body 90 of the front accessory panel, showing the audio player 114 mounted therein. The solid panel constituting central panel body bottom surface 100 is illustrated, and constitutes a structure that may be further adapted to accommodate under-panel lighting in the interior vehicle compartment, or installation of additional electronic instrumentation or accessories, etc.

FIG. 17 is a perspective view of a portion of the recreational vehicle of FIGS. 1-3, showing details of the side door of the invention, in one embodiment thereof.

The components in FIG. 17 are numbered consistently with the prior drawings of the illustrative recreational vehicle embodiment.

As shown in FIG. 17, the side door 32 is hingedly associated with a door mounting panel 34. The door mounting panel 34 is secured to the roll cage 30, by suitable securement elements, such as clamps, connectors, couplings, mechanical fasteners, etc.

FIG. 18 is a perspective view of the recreational vehicle of FIG. 17, showing the ready manual removal of the side door, involving lifting of same off its hinge spindles.

The side door in a preferred embodiment is formed symmetrically of twin sheets in a thermoforming process yielding a door that is able to be used both as a left-hand “driver side” door or alternatively as a right-hand “passenger side” door.

Such symmetrical character and interchangeably between right- and left-side usage of the door permits ready replacement of the door, since only one type is required in inventory to accommodate both sides of the accessorized vehicle. Additionally, to the extent that rugged terrain usage of the vehicle results in scoring, marring or other damage on the exterior surface of the door as installed on the vehicle, such door can simply be switched out with the opposite side door. By such action, the blemished surface, formerly on the exterior door surface on one side of the vehicle, after the switch resides on the interior compartment side of the repositioned door. The other side door subsequent to the switch then presents an unblemished exterior surface at the side of the vehicle at which the first door was exteriorly damaged.

FIG. 19 is a perspective close-up view of the side door assembly of FIGS. 17 and 18, showing details of the side door and door mounting panel assembly.

The side door 32 as illustrated is provided with an upper door hinge 46 and a lower door hinge 48, for coupling the door with the upper door mount spindle 42 and the lower door mount spindle 44 on the door mounting panel 34.

By such arrangement, the door can simply be lifted to remove same from the spindles 42 and 44, to accommodate door removal from the chassis, or switching of respective doors of the vehicle, as described above.

Doors according to the invention can be of any suitable style. For example, the side doors may be configured as so-called half-doors, of the type shown in FIG. 19, meaning that the door has a vertical height that extends approximately to the mid-height of the opening to the interior compartment that is circumscribed by the roll cage at the side of the vehicle.

The doors alternatively can be configured as full-height doors, but in general, consistent with the character of the recreational vehicle, and the desire for visibility and an “open air” character of the interior compartment, half-doors are typically preferred.

As a still further modification, the doors may be formed as twin sheet thermoformed half-doors that then are coupled with window elements extending from the mid-height upper extremity of the main door body to the full height of the roll cage opening at the side of the vehicle.

FIG. 20 is a perspective view of a recreational vehicle door 32, according to one embodiment of the invention.

The door 32 as illustrated is formed of half-sections including a door left half section 140 and door right half section 142, each separately formed by thermoforming and bonded to one another at the thermoforming joint 144 by mating of the two half sections for consolidation thereof, in a manner analogous to that employed for forming the vehicular top. The door 32 at its leading edge portion includes an upper hinge opening 50 and a lower hinge opening 52, to accommodate the hinges 46 and 48 as shown in FIG. 19.

In addition, the door is formed at an upper part of its trailing edge portion with a door lockset opening 56, to accommodate the locking or closure structure, which may for example be of the type as shown in FIGS. 17 and 18 herein.

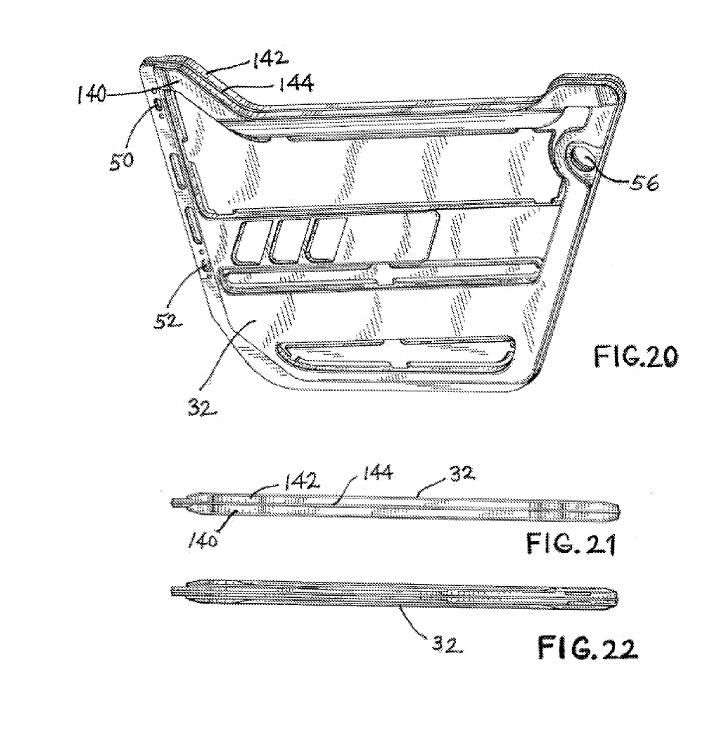

FIG. 21 is a top plan view of the door of FIG. 20, and FIG. 22 is a bottom plan view of such door.

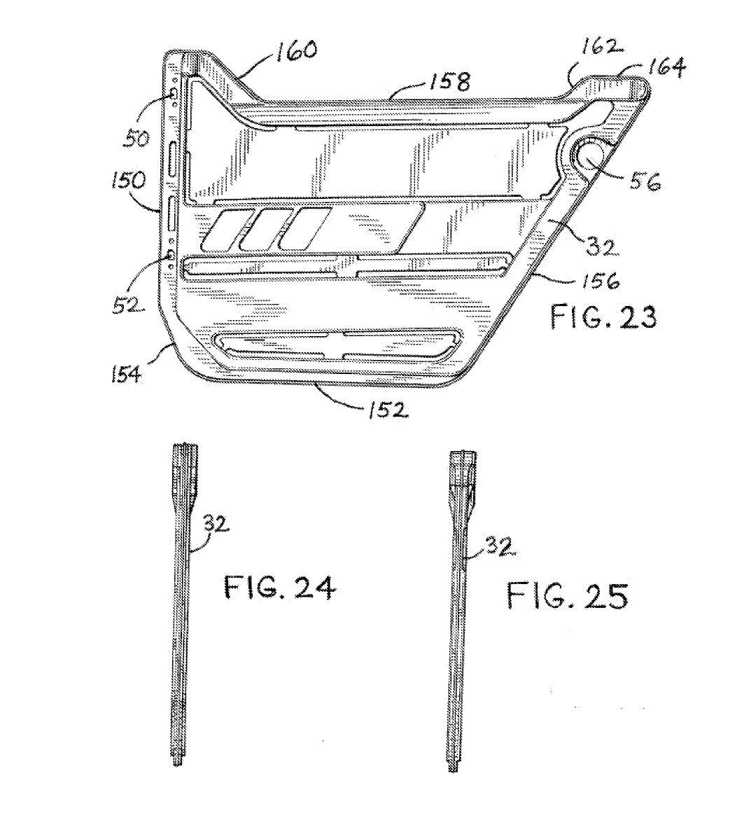

FIG. 23 is a side elevation view of the door 32 of FIG. 20, such door being provided in duplicate and the doors being symmetrical to one another, as previously described. The parts and features of the door shown in FIG. 23 are numbered correspondingly to the numbering of parts and features in FIGS. 20-22. The door 32 at its leading edge 150 has a vertical edge profile, so that the door when hung on the spindles of the door mounting panel swings about a vertical axis, as the door is opened or closed.

The door at its bottom edge 152 has a horizontal edge profile, as illustrated. Between the leading edge 150 and bottom edge 152, the door has a downwardly and rearwardly flaring edge profile constituting the transition edge 154. The door at its trailing edge portion has a rearwardly and upwardly flaring edge 156, so that the trailing edge 156 and bottom edge 152 define an obtuse angle (i.e., the angle subtended by the edges 152 and 156) therebetween.

The top edge 158 of the door is generally horizontal, and at its leading edge portion intersects a forwardly and upwardly flaring transition edge 160. The top edge 158 at its rearward portion intersects a rearwardly and upwardly flaring transition edge 162 that in turn intersects rear top edge 164, such rear top edge being generally horizontal.

FIG. 24 is a front elevation view of the door of FIG. 23, and FIG. 25 is a rear elevation view of such door.

The vehicular top and side doors of the present invention are thermoformed, by a twin sheet thermoforming process. Although twin sheets thermoforming processes have been known per se, prior to the present invention, for forming various articles of thermoplastic materials of construction, it was not established or predictable that thermoforming of a complex and geometrically highly variable structure such as the vehicular top and side doors of the present invention could be commercially mass-produced by twin sheet thermoforming techniques. In fact, there was substantial doubt from a plastics manufacturing perspective that twin sheet thermoforming could be usefully employed to form such vehicular top and side doors, and conventional manufacturing wisdom suggested that solid molding techniques, e.g., injection molding, would be the appropriate methodology for manufacturing such vehicular top and side doors in a consistent, reproducible and commercially acceptable manner.

This ostensible disincentive to use twin sheet thermoforming for manufacture of the vehicular top and side doors was due to the fact that twin sheet thermoforming requires the ability during the molding process for each of the respective sheets to be deformable into its respective molding cavity, with removal of gas creating a vacuum to force the sheet into tight conformity with the mold cavity surfaces.

Where the mold cavity is of a geometrically simple and “open” structure, such gas removal and suctioning of the thermoplastic sheet into contact with the mold surfaces is readily effected.

Where, however, the mold and product part are highly variable in geometric shape and topology over an extended area, as in the case of the vehicular top and side doors for a recreational vehicle, it is not expected to be possible to achieve the necessary degree of “tight” conformity to the highly varied geometric shape and topology of the required mold surfaces, while at the same time retaining the ability to achieve continuous bonding between the respective molded sheet sections of the twin sheet molded structure, as such molded sheet sections are brought into contact with one another for bonding and consolidation to yield a unitary product article.

In fact, these expectations were borne out during the development of the present invention, by repeated failures of the twin sheet thermoforming process, as 300 thermoformed vehicular tops of the geometry illustrated in FIGS. 4-10 were manufactured without achievement of acceptable bonding seams between the respective molded sheets. These 300 rejects reinforced the initial perception that twin sheet thermoforming was not a commercially viable method for manufacture of the vehicular top and side doors.

Continued persistence in the developmental effort, however, resulted in the discovery of the present invention, as the conditions and techniques of the twin sheet forming process were successively varied in an effort to determine critical characteristics of the process that would permit fully bonded twin sheet molded vehicular tops and doors of intricate geometric character and highly variable topology to be formed.

As a result of the extended investigation of the thermoforming process to identify aspects critical to manufacturability of thermoformed vehicular tops and doors with continuous bonded seams between the respective molded sheets of the structure, it was discovered that mold orientation and molding sequence of thermoplastic sheets displaying “grain-sidedness” is critical to achieving continuous bonded seams in a reliable manner.

Using raw sheets of polymeric stock that exhibit a “grain” orientation, with one main surface of the sheet exhibiting a very smooth and non-grained appearance (ungrained side), and the other main surface exhibiting a grained appearance (grained side), it was found that thermoforming the sheet stock with the grain side of a first sheet facing downwardly and positioned over a bottom mold, and with the grain side of a second sheet facing upwardly and positioned under a top mold, with vacuum thermoforming of the bottom sheet first, followed by vacuum thermoforming of the top sheet, and subsequent mating of the respective molds to form the consolidated molded twin sheet structure, permitted continuously bonded product articles of superior character to be consistently achieved.

This discovery was unexpected and surprising in character, given the geometric irregularities and widely varying topology of the product articles, involving closely spaced land and recess features, curved and compound curved surfaces having small radii of curvature, sharp edges and surface transitions, and small-sized features and variant regions of the product article, which must be replicated in the molds to present the same conformation and topology to the sheets being vacuum thermoformed.

The discovery also was unexpected and surprising, given the geometric irregularities and widely varying topology of the product articles, due to the perceived difficulty of removing gas and exerting uniform vacuum force during the vacuum thermoforming process in an efficient and effective manner.

Thus, although the vehicular top and doors of the present invention did not appear to be susceptible to manufacturing by twin sheet vacuum thermoforming techniques, for a variety of reasons, it nonetheless was surprisingly and unexpectedly discovered that vehicular top and door articles could be reproducibly manufactured by twin sheet vacuum thermoforming with achievement of continuous bonding of the twin sheet half-sections to one another.

In other embodiments of the invention, it has been found it beneficial to utilize thermoplastic sheets of different thickness for the respective half-sections of the product article. For example, a greater sheet thickness of the polymeric sheet can be used to form the bottom half-section of the product article, in relation to the sheet thickness of the polymeric sheet that is employed to form the top half-section of the product article. In various embodiments, the top half-section is initially molded, prior to the bottom half-section being molded and the two molded half-sections then being brought into contact for bonding of the respective half-sections to one another.

As an illustrative example, the bottom sheet of polymeric material in various embodiments can have a thickness that is in a range of from 0.10 inch to 0.25 inch, with the top sheet of polymeric material having a thickness that is in a range of from 0.08 inch to 0.22 inch, with the bottom sheet being thicker than the top sheet, and an ABS material being employed. The specific thicknesses of the respective sheets employed in the twin sheet thermoforming process to form the vehicular top and door articles of the invention, utilizing any of various suitable polymeric materials, is readily determinable within the skill of the art, in light of the disclosure herein.

The top and door articles of the present invention embody a substantial advance in the art. In contrast to injection molded or cast articles, the twin sheet thermoformed articles of the invention are hollow and therefore entail a substantial reduction in weight, in relation to corresponding injection molded or cast solid-body articles.

Further, although initially perceived as a significant impediment to twin sheet vacuum thermoforming manufacture, the ribbed, landed, valleyed, cavitied and generally geometrically complex character of the top and door articles of the invention provides such articles with a structurally robust character, consistent with their subsequent use as structural components of off-road vehicles.

By way of example, the following process illustrates a fabrication methodology that in generalized application can be employed to form the vehicular top and door articles of the invention.

### EXAMPLE 1

A twin sheet thermoforming process is conducted, using single-cavity cast aluminum molds and different thicknesses of material for forming the upper and lower half-sections of a vehicular top article.

The mold for the bottom half-section of the vehicular top article is mounted to a top platen in a forming machine. The sheet is ABS plastic, 0.187 inch in thickness. The textured (grained) side of the sheet is oriented toward the mold.

The mold for the top half-section of the vehicular top is mounted to the bottom platen in the forming machine. The sheet is ABS plastic, 0.156 inch in thickness, and is oriented with the textured side of the sheet facing the mold.

Both thicknesses of sheet material are provided at a loading station. The sheets are loaded into the machine alternating with the grain turned down for the mold on the bottom platen and grain turned up for the mold on the top platen. Skids are identified noting the frames (odd or even) in which the sheets from that particular skid are to be loaded, as well as the direction to which the grain side of the sheet is to be turned. For example, an “Even Tex. ↑” marking refers to an even-numbered frame, with the textured side turned up. The frames are numbered 1, 2, 3 and 4. Frames 1 and 3 are odd, and frames 2 and 4 are even.

The sheets must be clean on both sides and properly centered in machine frames when loading. The mold on the bottom will form first. After forming, frames will open and the mold will retract with the half-section still in the mold. The next sheet then will rotate into position and is formed by the mold on the top platen, following which the two molds come together to form the twin sheet vehicular top. The molds thereupon retract, leaving the formed vehicular top in the machine.

The formed vehicular top next is lifted up and away from the lift table of the machine, taking care to avoid any damage or scratches of the top. The molded top thereupon is placed on a bandsaw deck and examined to verify that it has been formed tightly with complete mold copying, as a completely formed article, free of rolls, creases, and warpage.

Next, the article is trimmed and allowed to cool, following which a final quality assurance check is conducted.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A twin sheet vacuum thermoformed vehicular top, adapted for mounting on a roll cage of a recreational vehicle, said vehicular top comprising top and bottom sections thermally bonded to one another along a continuous peripheral edge seam therebetween to enclose an interior void volume bounded by said top and bottom sections and said peripheral seam, wherein each of said top and bottom sections has an exterior surface that is grained and an interior surface that is ungrained.

2. The vehicular top of claim 1, wherein each of the top and bottom sections is formed of material including a thermoplastic material selected from the group consisting of acrylonitrile butadiene styrene (ABS), fluoropolymers, polyamides, polyarylates, polycarbonate, polyimides, polyamideimides, polyetherimides, polyoxymethylene (POM acetal), polyphenylene oxide, polyaryletherketones, polysulfones, polyethersulfones, polyphenylene sulfides, and liquid crystal polymers, and copolymers of monomers of the foregoing polymers, and blends and composites including any of the foregoing.

3. The vehicular top of claim 1, wherein each of the top and bottom sections is formed of material including a thermoplastic material in a formulation further containing at least one additive selected from the group consisting of anti-oxidants, uv stabilizers, fillers, pigments, colorants, anti-static agents, plasticizers, and mold release additives.

4. The vehicular top of claim 1, wherein each of the top and bottom sections is formed of material including acrylonitrile butadiene styrene (ABS) copolymer.

5. The vehicular top of claim 4, wherein the ABS copolymer comprises a filler.

6. The vehicular top of claim 5, wherein said filler comprises carbon black.

7. The vehicular top of claim 1, further comprising electrical circuitry in the interior void volume thereof.

8. The vehicular top of claim 7, adapted to mount headlamps on a frontal portion thereof, wherein each of said headlamps is coupled with said electrical circuitry.

9. The vehicular top of claim 7, adapted to mount audio speakers on a frontal underside portion thereof, wherein each of said audio speakers is coupled with said electrical circuitry.

10. The vehicular top of claim 9, further adapted to mount additional audio speakers on a rear underside portion thereof, wherein each of said additional audio speakers is coupled with said electrical circuitry.

11. The vehicular top of claim 1, including a front portion accessory panel depending downwardly from a front portion of the vehicular top and including accessorizing panels.

12. The vehicular top of claim 11, wherein the front portion accessory panel includes openings therein for mounting of audio speakers.

13. The vehicular top of claim 12, wherein the front portion accessory panel includes a central panel body extending rearwardly from a main surface portion of the panel, and terminating in a panel including at least one openings for mounting of user accessories.

14. The vehicular top of claim 13, wherein said user accessories include at least one accessory selected from the group consisting of audio players, clocks, GPS devices, displays, radios, communications systems and computer systems and components.

15. The vehicular top of claim 12, wherein the front portion accessory panel is adapted for mounting therein of interior compartment lighting elements.

16. The vehicular top of claim 1, wherein the top section includes multiple rearwardly and outwardly flaring raised surface portions, extending from a front portion to a rear portion of the vehicular top.

17. The vehicular top of claim 16, wherein each of said raised surface portions increases in height from the front portion to the rear portion of the vehicular top.

18. The vehicular top of claim 1, wherein the bottom section includes a multiplicity of elongate ribs in a central portion thereof, extending laterally across a substantial part of the width of the bottom section.

19. The vehicular top of claim 1, wherein the top is shaped to conformably mate with the roll cage of the recreational vehicle.

20. The vehicular top of claim 1, including a rear accessory panel depending downwardly from a rear portion of the top.

21. The vehicular top of claim 20, wherein the rear accessory panel includes openings therein for mounting of audio speakers.

22. The vehicular top of claim 21, wherein the rear accessory panel includes electrical circuitry in an interior volume of the panel.

23. A twin sheet vacuum thermoformed door, adapted for mounting on a roll cage of a recreational vehicle, said door comprising first and second sections thermally bonded to one another along a continuous peripheral edge seam therebetween to enclose an interior void volume bounded by said first and second sections and said peripheral seam, wherein each of said first and second sections has an exterior surface that is grained and an interior surface that is ungrained.

24. The door of claim 23, hingedly associated with a door mounting panel.

25. The door of claim 23, wherein each of the first and second sections is formed of material including a thermoplastic material selected from the group consisting of acrylonitrile butadiene styrene (ABS), fluoropolymers, polyamides, polyarylates, polycarbonate, polyimides, polyamideimides, polyetherimides, polyoxymethylene (POM acetal), polyphenylene oxide, polyaryletherketones, polysulfones, polyethersulfones, polyphenylene sulfides, and liquid crystal polymers, and copolymers of monomers of the foregoing polymers, and blends and composites including any of the foregoing.

26. The door of claim 23, wherein each of the first and second sections is formed of material including a thermoplastic material in a formulation further containing at least one additive selected from the group consisting of anti-oxidants, uv stabilizers, fillers, pigments, colorants, anti-static agents, plasticizers, and mold release additives.

27. The door of claim 23, wherein each of the first and second sections is formed of material including acrylonitrile butadiene styrene (ABS) copolymer.

28. The door of claim 27, wherein the ABS copolymer comprises a filler.

29. The door of claim 28, wherein said filler comprises carbon black.

30. An accessory kit for accessorizing a recreational vehicle including a roll cage structure, said kit comprising:
(b) a twin sheet vacuum thermoformed vehicular top, adapted for mounting on a roll cage of a recreational vehicle, said vehicular top comprising top and bottom half-sections thermally bonded to one another along a continuous peripheral edge seam therebetween to enclose an interior void volume bounded by said top and bottom half-sections and said peripheral seam, wherein each of said top and bottom half-sections has an exterior surface that is grained and an interior surface that is ungrained; and
(c) twin sheet vacuum thermoformed doors, adapted for mounting on a roll cage of a recreational vehicle, said doors comprising first and second half-sections thermally bonded to one another along a continuous peripheral edge seam therebetween to enclose an interior void volume bounded by said first and second half-sections and said peripheral seam, wherein each of said first and second half-sections has an exterior surface that is grained and an interior surface that is ungrained.

31. The accessory kit of claim 30, further comprising door mounting panels, each adapted to be coupled to the roll cage of the recreational vehicle, at a respective side thereof, with each door mounting panel including hinge spindles secured thereto, and wherein each of the doors includes door hinges secured thereto and arranged to cooperatively engage the hinge spindles of a said door mounting panel for pivoting hinged movement of the door in opening and closing of same when the door is engaged with the spindles of a door mounting panel when the door mounting panel is secured to the roll cage of a recreational vehicle.

32. The accessory kit of claim 30, further comprising a foldable windshield adapted for coupling to the roll cage of a recreational vehicle.

33. The accessory kit of claim 30, further comprising a rear bumper adapted for mounting on a chassis of a recreational vehicle.

34. The accessory kit of claim 30, further comprising a foldable windshield adapted for coupling to the roll cage of a recreational vehicle, and a rear bumper adapted for mounting on a chassis of the recreational vehicle.

35. The accessory kit of claim 34, further comprising retention elements mountable on a hood of a recreational vehicle and adapted to positionally retain the foldable windshield in a down position on said hood.

36. The accessory kit of claim 30, including the vehicular top and doors contained in a package.

37. The accessory kit of claim 36, further comprising printed assembly and operating instructions for accessorizing a recreational vehicle with the components of the kit.

38. The accessory kit of claim 31, further comprising securement elements for securing the vehicular top and door mounting panels to the roll cage of the vehicle.

39. The accessory kit of claim 38, wherein said securement elements comprise at least one element selected from the group consisting of mechanical fasteners, couplings, clamps, and brackets.

40. The accessory kit of claim 30, wherein each of the first and second sections of the doors is symmetrical in relation to the other.

41. A recreational vehicle including a roll cage arranged to surround an interior compartment of the vehicle, said recreational vehicle including at least one of:
(a) a twin sheet vacuum thermoformed vehicular top, mounted on the roll cage of the recreational vehicle, said vehicular top comprising top and bottom sections thermally bonded to one another along a continuous peripheral edge seam therebetween to enclose an interior void volume bounded by said top and bottom sections and said peripheral seam, wherein each of said top and bottom sections has an exterior surface that is grained and an interior surface that is ungrained; and
(b) twin sheet vacuum thermoformed doors secured to the roll cage of the recreational vehicle at respective sides thereof, each of said doors comprising first and second sections thermally bonded to one another along a continuous peripheral edge seam therebetween to enclose an interior void volume bounded by said first and second sections and said peripheral seam, wherein each of said first and second sections has an exterior surface that is grained and an interior surface that is ungrained.

42. The recreational vehicle of claim 41, wherein each of the first and second sections of the doors is symmetrical in relation to the other.

43. The recreational vehicle of claim 41, wherein each of the doors at its front leading edge has a vertical edge profile, at its bottom edge has a horizontal edge profile, between the leading edge and the bottom edge has a downwardly and rearwardly flaring edge profile, at its trailing edge has a rearwardly and upwardly flaring edge profile, at its top edge has a generally horizontal edge profile that at a leading edge portion intersects a forwardly and upwardly flaring transition edge profile, and that at a rearward portion intersects a rearwardly and upwardly flaring transition edge profile that in turn intersects a rear top edge having a generally horizontal edge profile.

44. A method of making an article selected from among recreational vehicle tops and side doors, said method comprising forming complementary molded sections of said article by a twin sheet vacuum thermoforming process, and mating said complementary sections under elevated temperature conditions to form a bonded unitary article including the molded sections enclosing an interior void volume, wherein each of said molded sections has an exterior surface that is grained and an interior surface that is ungrained.

45. The method of claim 44, wherein each of twin sheets of said twin sheet vacuum thermoforming process is of a different thickness.

46. The method of claim 44, wherein each of twin sheets of said twin sheet vacuum thermoforming process comprises a carbon black-filled ABS sheet.
